(19) United States
(12) Patent Application Publication
(10) Pub. No.: US 2022/0390604 A1
(43) Pub. Date: Dec. 8, 2022

(54) TOF APPARATUS, TOF SYSTEM, INSTALLATION STATUS NOTIFICATION METHOD

(71) Applicant: Hitachi-LG Data Storage, Inc., Tokyo (JP)

(72) Inventor: Seiji INABA, Tokyo (JP)

(21) Appl. No.: 17/720,169

(22) Filed: Apr. 13, 2022

(30) Foreign Application Priority Data
Jun. 4, 2021 (JP) 2021-094208

(51) Int. Cl. G01S 17/10; G01S 17/894; G01S 7/4865

(52) U.S. Cl. CPC G01S 17/10; G01S 17/894; G01S 7/4865

(57) ABSTRACT

Provided are a TOF apparatus, a TOF system, and an installation status notification method that can automatically determine the quality of installation and reduce the loss of performing re-construction work. The TOF apparatus includes a processor. The processor executes an anomaly determination program, which is a program used to determine whether the installation state is normal or anomaly. By executing the anomaly determination program, the processor determines whether the installed state is normal or anomaly based on at least one of the viewpoints of the installation angle, the influence of interference, the field of view, and the measurement distance, and notifies the determination result.

### CROSS-REFERENCE TO RELATED APPLICATION

The present application claims priority from Japanese application JP2021-094208, filed on Jun. 4, 2021, the contents of which is hereby incorporated by reference into this application.

### BACKGROUND OF THE INVENTION

### 1. Field of the Invention

The present invention relates to a TOF apparatus, a TOF system, and an installation status notification method.

### 2. Description of the Related Art

Conventionally, a TOF apparatus is known that measuring the distance to an object based on the TOF (Time Of Flight) method that measures the distance by the flight time until the irradiation light is reflected by the object and returns. JP-A-2020-56698 discloses this type of TOF apparatus.

That is, JP-A-2020-56698 discloses a distance measurement image pickup apparatus including a light emitting unit, a light receiving unit, and a distance computation unit. The light emitting unit emits pulsed irradiation light emitted by a light source such as a laser diode (LD) or a light emitting diode (LED). The light receiving unit exposes the pulsed reflected light that is irradiated and reflected by the object and returned by an image sensor such as a CCD or CMOS in which pixels are arranged two-dimensionally, and converts it into an electric signal. The distance computation unit calculates the distance to the object from the output signal of the light receiving unit.

The TOF apparatus is often used for counting the number of people and acquiring flow lines, and may be installed on the ceiling of a store such as an apparel shop, for example. However, since the installation environment of the TOF apparatus affects the performance, there are not a few cases where re-construction work is performed to shift the installation location after the start of operation.

To explain an example, normally, the TOF apparatus is installed by the construction work by the contractor after conducting a field survey (also called the site investigation) in advance to determine the installation location and then giving instructions to the contractor. However, there are cases where the installation location is instructed to the contractor by looking only at the drawings at the site without making the field survey, and the quality of the installation may depend on the experience of the contractor. In addition, the accuracy may not be obtained after the start of operation, and from the viewpoint of accuracy, the construction work may be performed again after the start of operation.

Therefore, the present invention purpose to provide a TOF apparatus, a TOF system, and an installation status notification method that can automatically determine the quality of installation and reduce the loss of performing re-construction work.

### SUMMARY OF THE INVENTION

According to a first aspect of the invention, the following TOF apparatus is provided. TOF apparatus includes a processor. The processor executes an anomaly determination program to determine whether the installed state is normal or anomaly based on at least one of the viewpoints of the installation angle, the influence of interference, the field of view, and the measurement distance, and notifies the determination result.

According to a second aspect of the invention, the following TOF system is provided. TOF system includes a TOF apparatus, a display, and a processor. The processor executes an anomaly determination program to determine whether the TOF apparatus installed state is normal or anomaly based on at least one of the viewpoints of the installation angle, the influence of interference, the field of view, and the measurement distance, and display information of related to the determine on the display.

According to a third aspect of the invention, the following installation status notification method is provided. The installation status notification method is a method executed by the processor. The installation status notification method determines whether the TOF apparatus installed state is normal or anomaly based on at least one of the viewpoints of the installation angle, the influence of interference, the field of view, and the measurement distance, and the measurement distance, and notifies the determination result.

### Advantageous Effect

According to the invention, it is possible to provide a TOF apparatus, a TOF system, and an installation status notification method that can automatically determine the quality of installation and reduce the loss of performing re-construction work.

### BRIEF DESCRIPTION OF THE DRAWINGS

FIG. 1 is a diagram for explaining the configuration of the TOF sensor.

FIG. 2 is a hardware block diagram for explaining the configuration of the TOF sensor.

FIG. 3 is a flowchart for explaining an example of processing of the anomaly determination program.

FIG. 4 is a diagram showing an example of a state in which a TOF sensor is installed.

FIG. 5 is a diagram showing an example of an environment in which a TOF sensor is installed.

FIG. 6 is a hardware block diagram for explaining the configuration of the TOF system.

FIG. 7 is a flowchart for explaining an example of processing of the anomaly determination program.

FIG. 8 is a flowchart showing an example of processing when the determination of the angle anomaly is started.

FIG. 9 is a diagram showing a relationship between the installation angle and the arrow display, and an example of a display image when the installation angle is anomaly.

FIG. 10 is a flowchart showing an example of processing when the determination of the field of view anomaly is started.

FIG. 11 is a diagram showing an example of a display image when the field of view is anomaly.

FIG. 12 is a flowchart showing an example of processing when the determination of the distance anomaly is started.

FIG. 13 is a diagram showing an example of a display image when the distance is anomaly.

FIG. 14 is an example of an image acquired by the TOF sensor which is anomaly state has been resolved.

### DESCRIPTION OF THE PREFERRED EMBODIMENTS

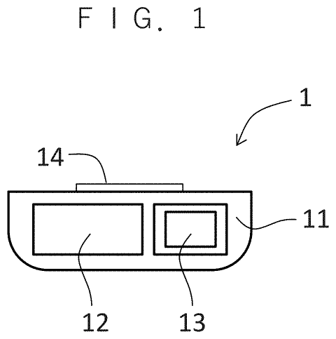

First, a configuration of a TOF sensor (TOF apparatus) of the first embodiment will be described with reference to FIG. 1. The TOF sensor 1 can acquire an image of distance data and an IR image (luminance image), and can measure the distance to an object. As shown in FIG. 1 the TOF sensor 1 includes a housing 11, a light emitting unit 12, a light receiving unit 13, and a mounting unit 14. The light emitting unit 12 emits pulsed irradiation light emitted by a light source such as a laser diode (LD) or alight emitting diode (LED). The light receiving unit 13 exposes the pulsed reflected light that is irradiated and reflected by the object and returned by an image sensor such as a CCD or CMOS in which pixels are arranged two-dimensionally, and converts it into an electric signal. The light emitting unit 12 and the light receiving unit 13 can be provided at appropriate positions so that appropriate measurement can be performed. In this embodiment, as shown in FIG. 1, the light emitting unit 12 and the light receiving unit 13 are provided as to be adjacent to each other.

The mounting unit 14 is a unit for mounting the apparatus, and may have an appropriate configuration. The mounting portion 14 can have, for example, a configuration in which a plurality of screw holes are formed and construction using screws is possible. Further, the mounting portion 14 may have a configuration that enables construction using a member such as a fixer or a bracket separately.

Further, the TOF sensor 1 may be configured so that the installation angle can be changed by rotating the TOF sensor 1 with respect to the installation portion. Therefore, the mounting unit 14 may have an appropriate rotation mechanism for changing the installation angle. Further, the TOF sensor 1 may be installed by using separately a member having a rotation mechanism capable of changing the installation angle. The TOF sensor 1 is used by being installed to the upper surface side (for example, the ceiling) inside the structure. Then, the TOF sensor 1 can change the installation angle with respect to the installed portion (for example, the installation surface of the ceiling).

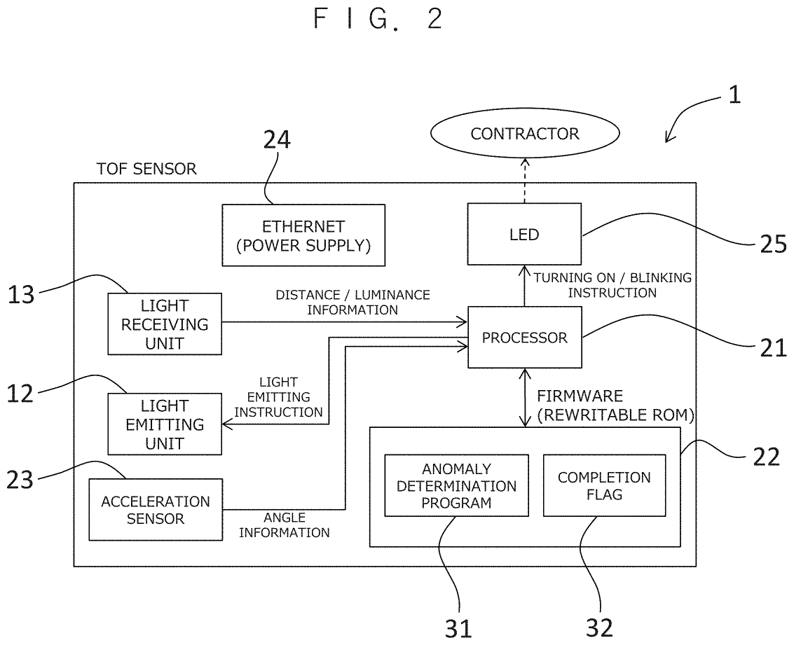

Next, the configuration of the TOF sensor will be described with reference to the hardware block diagram of FIG. 2. As shown in FIG. 2, the TOF sensor 1 includes a processor 21 and firmware 22. The processor 21 has a calculation function, and as an example, it can be a CPU (Central Processing Unit). The firmware 22 is a rewritable ROM, and stores data used by the processor 21 for processing. The firmware 22 stores an anomaly determination program 31 used for determining whether the installed state is normal or anomaly. Further, the firmware 22 is arranged with a completion flag 32, which is a flag used in executing the anomaly determination program 31.

The TOF sensor 1 includes an acceleration sensor 23 (installation angle detection sensor), a power supply 24, and a LED 25 (lamp). The acceleration sensor 23 is appropriately provided so that the tilt angle of the apparatus with respect to the installation surface can be detected as angle information. In the present embodiment, when considering a three-axis rectangular coordinate system (when considering the direction horizontal to the installation surface and viewing the light emitting unit 12 and the light receiving unit 13 as the Z axis, the direction perpendicular to the installation surface as the Y axis, and the direction horizontal to the installation surface and perpendicular to the Z-axis and Y-axis as the X-axis), the acceleration sensor 23 detects the tilt angle with respect to an installation surface at least around the X-axis and around the Z-axis.

The power supply 24 is the configuration used for supplying electric power. In this embodiment, power is supplied by PoE (Power of Ethernet), and a LAN cable is connected. The LED 25 can be configured by an appropriate LED lamp. The LED 25 is appropriately provided so that the contractor or the like can visually recognize it, and is used to notify the determination result in the execution of the anomaly determination program 31.

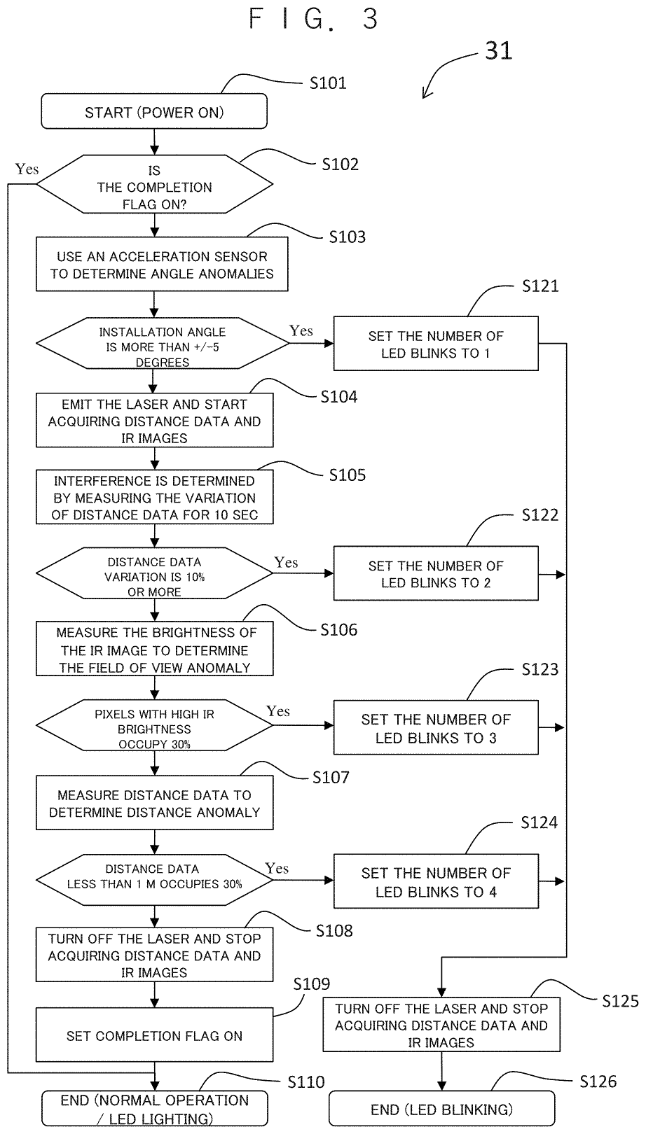

In the present embodiment, when the TOF sensor 1 is installed, the anomaly determination program 31 is executed. Next, an example of the processing of the anomaly determination program 31 will be described with reference to FIG. 3. FIG. 3 is a flowchart for explaining an example of processing of the anomaly determination program. Note that, the subject of the processing of the anomaly determination program 31 is the processor 21.

When the TOF sensor 1 is installed and power is supplied (step 101), the anomaly determination program 31 is executed, and first, a check is performed as to whether or not the completion flag 32 is on (step 102). Here, at the time of factory shipment, the completion flag 32 is set to off. Therefore, when the TOF sensor 1 is installed, the completion flag 32 is considered to be off. In the step 102, when the completion flag 32 is confirmed on, the process of step 110 described later is performed. On the other hand, when the completion flag 32 is confirmed off, using the angle information from the acceleration sensor 23, the determination as to whether or not the installation angle is normal is started (step 103).

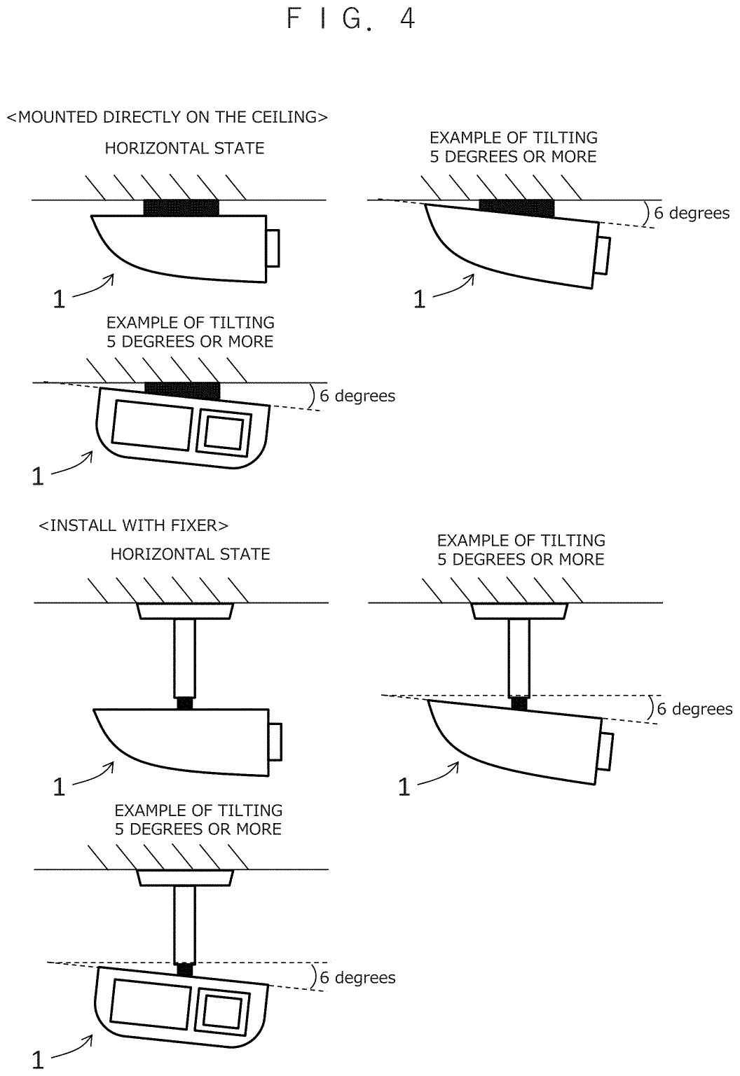

As shown in FIG. 4, the TOF sensor 1 is preferably installed in a horizontal state with respect to the installation surface, for example, when installing on the ceiling, it is preferably installed horizontally with respect to the ceiling surface. However, it may be tilted with respect to the installation surface. Further, even when a member such as a fixer or a bracket is used, it is considered difficult to install it horizontally with respect to the installation surface. Therefore, in the step 103, a determination as to whether or not the installation angle is appropriate (that is, a determination as to whether or not the installation angle is within a predetermined range) is performed.

In the present embodiment, in the step 103, when the installation angle of the apparatus with respect to the installation surface is determined less than plus or minus 5 degrees, a light emitting instruction is output to the light emitting unit 12, a laser is emitted (that is, the light source emits light), and acquisition of an IR image based on distance data and luminance information is started (step 104).

On the other hand, when it is determined that the installation angle of the apparatus is plus or minus 5 degrees or more with respect to the installation surface, the number of blinks of the LED 25 per predetermined time is set to one (step 121), the laser is turned off (that is, the light source is turned off), and the acquisition of the distance data and the IR image is stopped (step 125). Then, the step 126 described below is performed.

In the step 105, on the premise of an environment in which there is no movement of a person or an object (that is, on the premise that the distance data from the moving object is not acquired), the variation in the distance data acquired in step 104 is measured, and the presence or absence of interference is determined. That is, it is considered that there is no variation in the distance data from a non-moving object. Therefore, the presence or absence of interference is determined based on whether or not have a variation of a predetermined or more (it can be set as appropriate, and in this embodiment, 10% or more) in the distance data for a predetermined time (it is able to set as appropriate, and in this embodiment, 10 seconds). Note that, as an example, it is considered that the interference is caused by the influence of another TOF sensor or LiDAR installed nearby.

In the step 105, when it is determined that there is no variation of 10% or more in the distance data, the luminance of the IR image acquired in the step 104 is measured, and the field of view of anomaly is determined (step 106).

On the other hand, when it is determined that there is variation of 10% or more in the distance data, the number of blinks of the LED 25 per predetermined time is set to two (step 122), the laser is turned off (that is, the light source is turned off), and the acquisition of the distance data and the IR image is stopped (step 125). Then, the step 126 described below is performed.

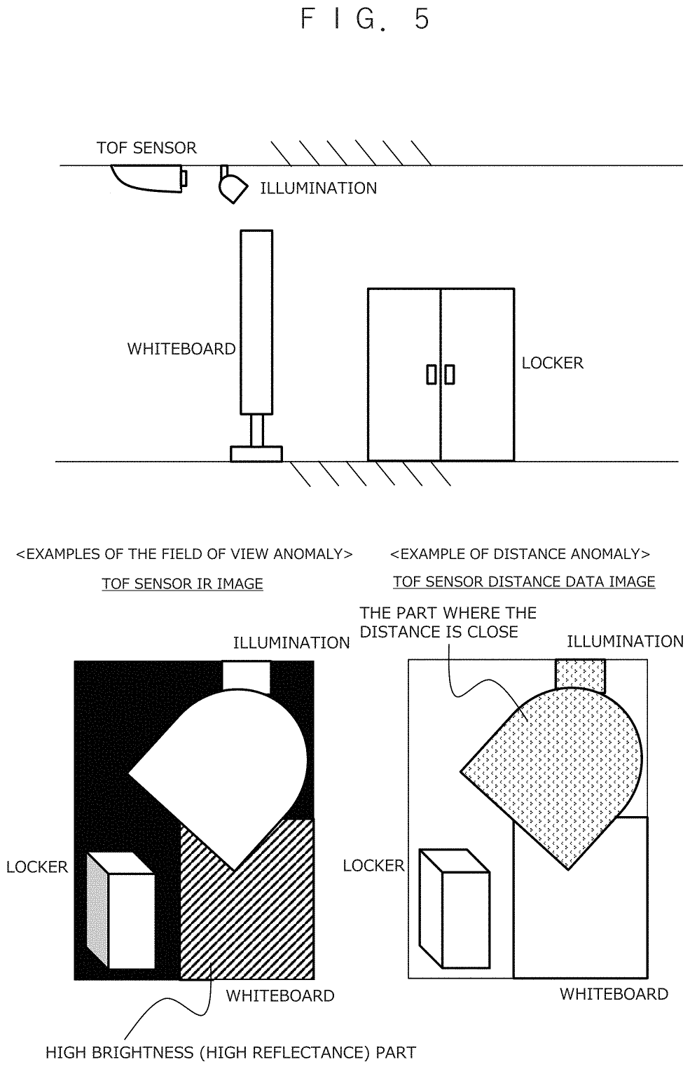

In the step 106, an anomaly of the field of view is determined from the viewpoint of luminance. For example, as shown in FIG. 5, it is conceivable that an object with high reflectance (whiteboard in this example) will generate a high-brightness portion of the IR image, narrowing the appropriate measurable range compared to normal, and narrowing the field of view. Therefore, it is determined whether or not the field of view is normal based on how many pixels having a predetermined brightness or higher are included in the IR image acquired in the step 104. Here, the criteria for this determination can be appropriately set, but in the present embodiment, when the pixels having a predetermined brightness or higher occupy 30% or more in the IR image, the anomaly of the field of view is determined.

In the step 106, when it is determined in the IR image that pixels having a predetermined brightness or more do not occupy 30% or more, a distance anomaly regarding whether or not the measurement distance is appropriate is determined based on the distance data acquired in the step 104 (step 107).

On the other hand, when it is determined that pixels having a predetermined brightness or more occupy 30% or more in the IR image, the number of blinks of the LED 25 per predetermined time is set to three (step 123), the laser is turned off (that is, the light source is turned off), and the acquisition of the distance data and the IR image is stopped (step 125). Then, the step 126 described below is performed.

In the step 107, an anomaly of the measurement distance is determined from the viewpoint of the distance to the object. For example, as shown in FIG. 5, an object close to the apparatus (illumination in this example) will generate a portion that cannot be properly measured, in the image of the distance data. Therefore, it is determined whether or not the measurement distance is normal based on the distance data acquired in the step 104. Here, the criteria for this determination can be appropriately set, but in the present embodiment, when the distance data of less than 1 meter occupies 30% or more in the image, the anomaly of the measurement distance is determined.

In the step 107, when it is determined that the distance data of less than 1 meter does not occupy 30% in the image, the laser is turned off (that is, the light source is turned off), and the acquisition of the distance data and the IR image is stopped (step 108). Then, the completion flag 32 is set to on (step 109). In the step 110, the LED 25 is turned on (that is, the LED is left on), and the processing of the anomaly determination program 31 is completed. By the step 110, the TOF sensor 1 is in a state of being able to operate normally.

On the other hand, when it is determined that the distance data of less than 1 meter occupies 30% or more in the image, the number of blinks of the LED 25 per predetermined time is set to four (step 124), the laser is turned off (that is, the light source is turned off), and the acquisition of the distance data and the IR image is stopped (step 125). Then, the step 126 described below is performed.

In the step 126, the LED 25 is blinked under the conditions set in the step 121, the step 122, the step 123, or the step 124 described above. Then, the processing of the anomaly determination program 31 ends. In the step 126, the completion flag 32 is not turned on, which is different from the step 110, it does not become a state of being able to operate normally. Therefore, in order to use the TOF sensor 1 normally, it is necessary to change the installation environment, execute the anomaly determination program 31 again, and turn on the completion flag 32.

According to the present embodiment, when an anomaly in the installation angle is determined, when it is determined that there is interference, when an anomaly in the field of view is determined, and when an anomaly in the measurement distance is determined, the abnormality is determined, since the LED 25 is blinked in different modes, the contractor or the like can easily grasp which type of anomaly is determined by paying attention to the LED 25.

In the installation of the TOF sensor 1, for example, it is conceivable that a step portion is formed at the installation location or a blind spot is generated by an existing installation object. For example, when the TOF sensor 1 is installed on the ceiling, it is conceivable that a step portion is formed on the ceiling or a blind spot is generated by illumination, an air conditioner, or the like. Then, for example, it is conceivable that the occurrence of a blind spot limits the irradiation of the irradiation light and the acquisition of the image, and the measurement accuracy is lowered, and the accuracy of the counting the number of people and the acquiring flow lines is lowered accordingly. In this way, the TOF sensor 1 is affected by the installation environment, but according to the present embodiment, since it is possible to determine whether the installation environment is appropriate and notify it, the installation work can be performed appropriately. Therefore, after the start of operation, it is possible to reduce the loss of performing the installation work again from the viewpoint of accuracy.

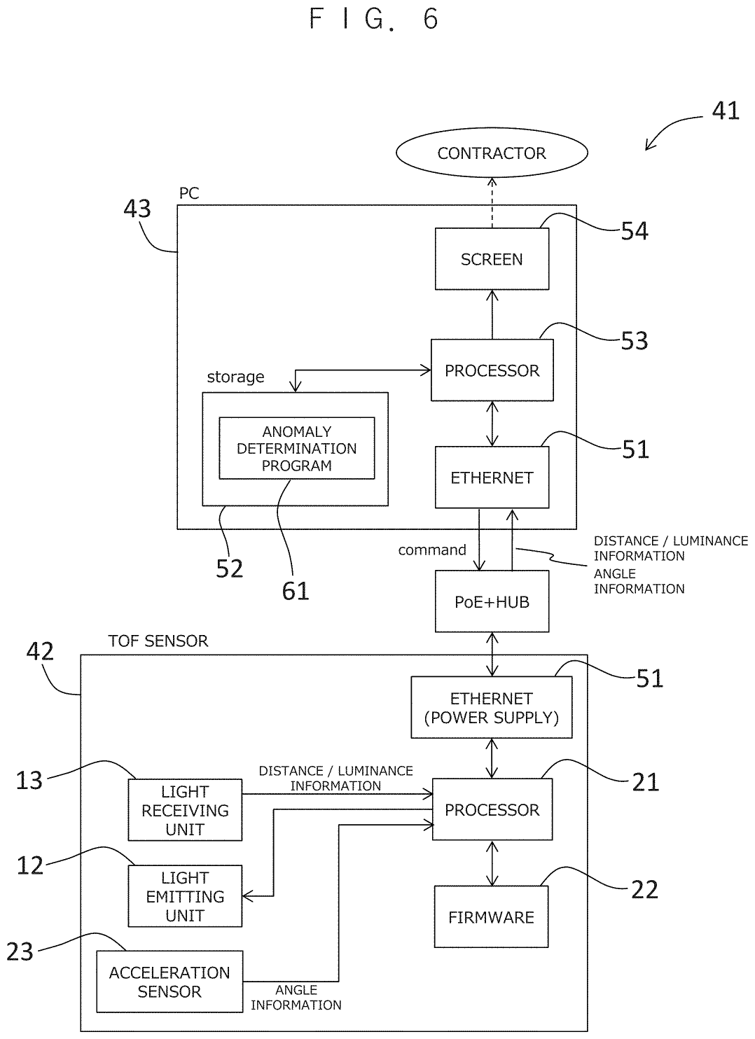

Next, the second embodiment will be described. In the second embodiment, an example of a TOF system using a TOF sensor will be described. FIG. 6 is a hardware block diagram for explaining the configuration of the TOF system. In addition, the same description as the content described in the first embodiment may be omitted.

As shown in FIG. 6, the TOF system 41 includes a TOF sensor 42 and a PC 43 (personal computer). The TOF sensor 42 and the PC 43 are configured to be able to perform communication based on the ethernet 51. Further, as compared with the case of the first embodiment, the configuration of the LED of the TOF sensor is omitted, and the PC 43 stores the anomaly determination program 61.

The PC 43 includes a storage 52, a processor 53, and a screen 54. The storage 52 is configured as an appropriate storage device for storing data, and may be, for example, an HDD (Hard disk drive) or a ROM. The storage 52 stores the anomaly determination program 61. The processor 53 has a calculation function, and can be a CPU as an example. The processor 53 can execute the anomaly determination program 61 stored in the storage 52. The screen 54 is composed of an appropriate display device such as a display. As will be described later, information is displayed on the screen 54 when the anomaly determination program 61 is executed.

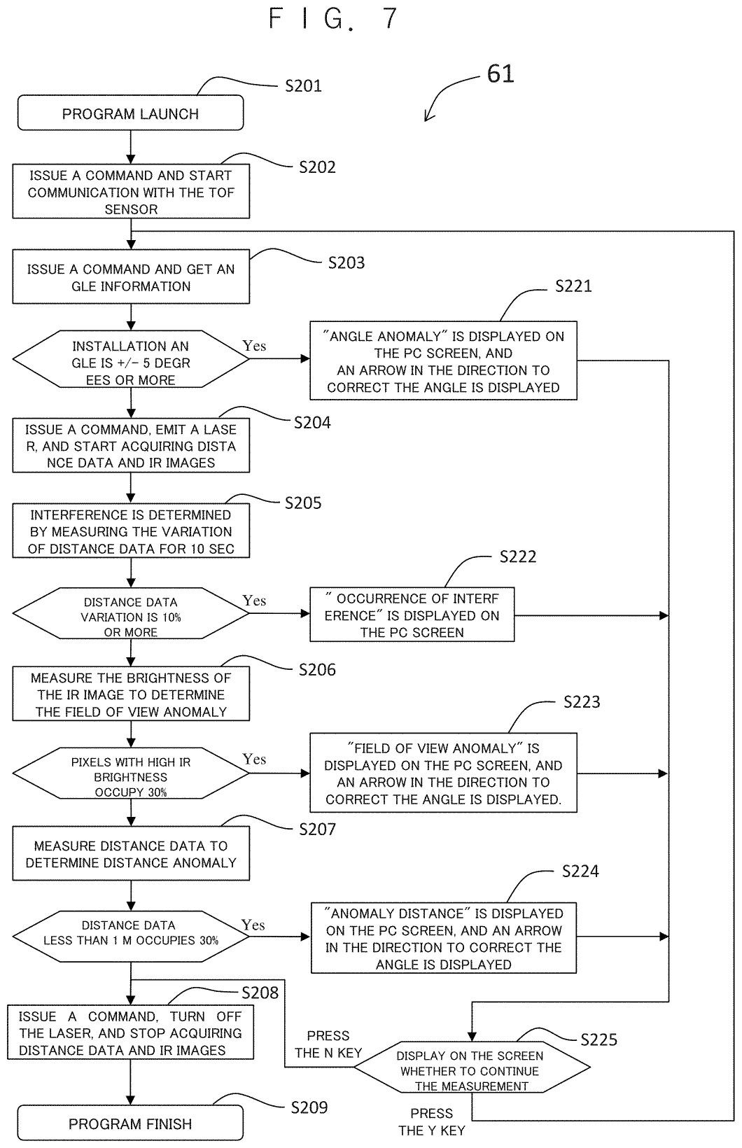

Next, an example of the processing of the anomaly determination program 61 will be described with reference to FIG. 7. FIG. 7 is a flowchart for explaining an example of processing of the anomaly determination program. The anomaly determination program 61 is executed by the processor 53 included in the PC 43.

When the TOF sensor 42 is installed, the anomaly determination program 61 is activated (step 201). Then, a command is issued to start communication with the TOF sensor (step 202), and a command is issued to acquire angle information which is information on the installation angle of the TOF sensor 42 (step 203). Then, it is determined whether or not the installation angle of the TOF sensor 42 is appropriate. In this embodiment, it is determined whether or not the installation angle is plus or minus 5 degrees or more.

Here, if it is determined that the installation angle is appropriate, step 204 described later is executed. On the other hand, when it is determined that the installation angle is not appropriate (that is, if an anomaly in the installation angle is determined), information indicating an angle anomaly and an arrow indicating a direction for correcting the angle are displayed on the screen 54 (step 221). Note that, the display mode of the information indicating the angle anomaly is not particularly limited as long as it can be grasped that the angle anomaly is present. For example, the angle anomaly may be shown by displaying the character information. Further, for example, by displaying a specific symbol, an angular anomaly may be indicated.

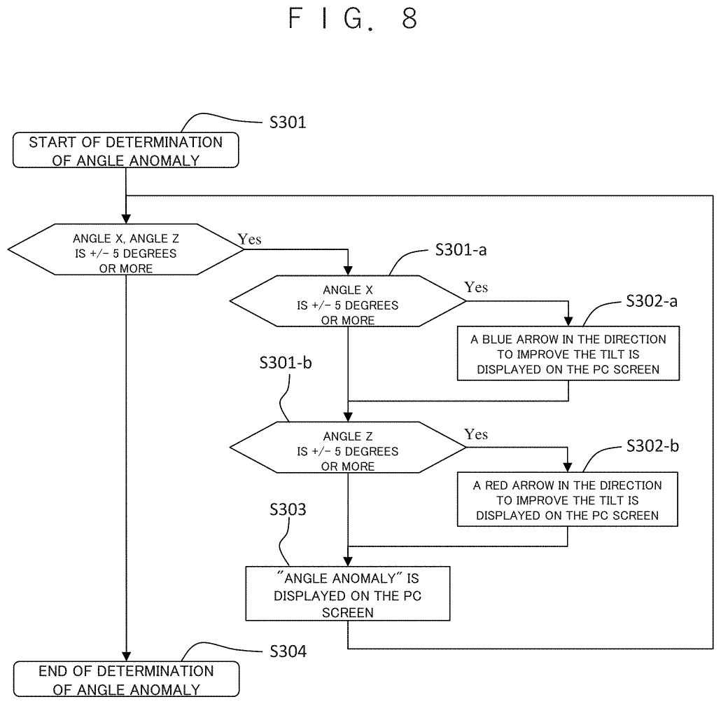

The details of the processing when the anomaly of the installation angle is determined will be described with reference to FIG. 8. FIG. 8 is a flowchart showing an example of processing when the determination of the angle anomaly is started. When the determination of the angle anomaly is started (step 301), it is determined whether or not there is an anomaly in the angle around the X axis (Angle X) (step 301-a), apart from this process, it is determined whether or not there is an anomaly in the angle around the Z axis (Angle Z) (step 301-b). Then, when it is determined in step 301-a that there is an anomaly in the angle around the X axis, a blue arrow indicating a direction for improving the inclination is displayed on the screen 54 (step 302-a). When it is determined in step 301-b that there is an anomaly in the angle around the Z axis, similarly, a red arrow indicating a direction for improving the inclination is displayed on the screen 54 (step 302-b). Further, information indicating an angle anomaly is displayed on the screen 54 (step 303). As in the above description, it can be considered that the Z-axis is horizontal to the installation surface and the direction in which the light emitting unit 12 and the light receiving unit 13 are viewed, and the X-axis is the direction horizontal to the installation surface and perpendicular to the Z-axis. Further, although an example in which step 301-b is processed after step 301-a has been described, the process according to step 301-b may be performed before the process according to step 301-a. Further, for example, the process according to step 303 may be before the arrow display process, and the timing for starting the process may be appropriately changed. Then, when the angle anomaly is resolved, the process ends (step 304). Here, in step 304, a process of ending the display of information may be performed.

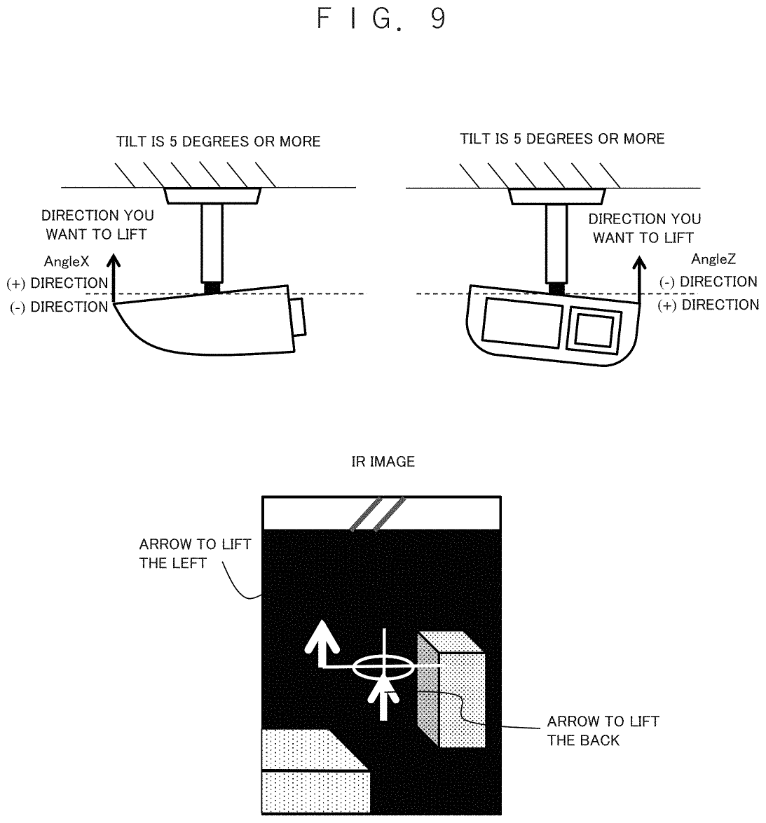

Next, an example of the display of the arrow displayed on the screen 54 will be described. FIG. 9 is a diagram showing an example of the relationship between the installation angle and the arrow display. As shown in FIG. 9, on the screen 54, an image in which a symbol indicating the device is superimposed on the IR image acquired by the TOF sensor 42 in the current installation state is displayed. As shown in FIG. 9, when the side where the light emitting unit 12 and the light receiving unit 13 are provided is the front side, when the rear side of the device is tilted by 5 degrees or more around the X axis so as to be away from the installation surface, a blue arrow is displayed at the bottom of the symbol to indicate lifting the rear side of the device. Also, when the left side of the device is tilted more than 5 degrees around the Z axis so as to be away from the installation surface, a red arrow indicating lifting the left side of the device is displayed on the left side of the symbol. In this way, an arrow indicating the direction for correcting the installation angle is displayed.

In this embodiment, an example in which a blue arrow is used for the angle around the X axis and a red arrow is used for the angle around the Z axis has been described. However, the display mode of the arrow is not particularly limited as long as the direction for improving the inclination can be appropriately displayed, and for example, different colors other than these may be used. Also, arrows of the same color may be displayed.

Then, the installation state can be changed with reference to the arrow displayed on the screen 54, and the angle anomaly can be resolved. Further, the screen 54 displays information for selecting whether to continue the measurement (step 225). Here, when the measurement is selected to be continued, the step 203 is executed again. On the other hand, when choosing not to continue the measurement, the step 208, described below, is performed. Note that, an appropriate configuration is used for selecting whether to continue the measurement (for example, a configuration for inputting with a keyboard or a touch panel is used).

In the step 204, a command is issued to cause the TOF sensor 42 to emit a laser. Then, the acquisition of the distance data and the IR image is started. After that, in the step 205, the presence or absence of interference is determined in the same manner as in the step 105 described above, and when it is determined that the variation in the distance data is not 10% or more, the step 206 is executed. On the other hand, when it is determined that the variation of the distance data is 10% or more, the step 222 is executed. In the step 222, information indicating the occurrence of interference is displayed on the screen 54. Note that, the display mode of the information indicating the occurrence of interference is not particularly limited as long as the occurrence of interference can be grasped. For example, display may be performed by character information, or display may be performed based on a specific symbol. Then, based on the information displayed on the screen 54, the interference can be resolved by changing the interference setting such as by changing the installation location. Further, similarly to the above, the screen 54 displays information for selecting whether to continue the measurement (step 225), when the measurement is selected to be continued, the step 203 is performed again. When choosing not to continue the measurement, the step 208 described below is performed.

In the step 206, an anomaly in the field of view is determined in the same manner as in the step 106 described above, and when it is determined that pixels having a predetermined brightness or higher do not occupy 30% or more in the IR image, the step 207 is executed. On the other hand, when it is determined that pixels having a predetermined brightness or more occupy 30% or more in the IR image, information indicating the field of view anomaly and an arrow indicating the direction for correcting the sensor (that is, the direction for correcting the field of view anomaly) are displayed on the screen 54 (step 223). Note that, the display mode of the information indicating the field of view anomaly is not particularly limited as long as the field of view anomaly can be grasped, as in the case described above.

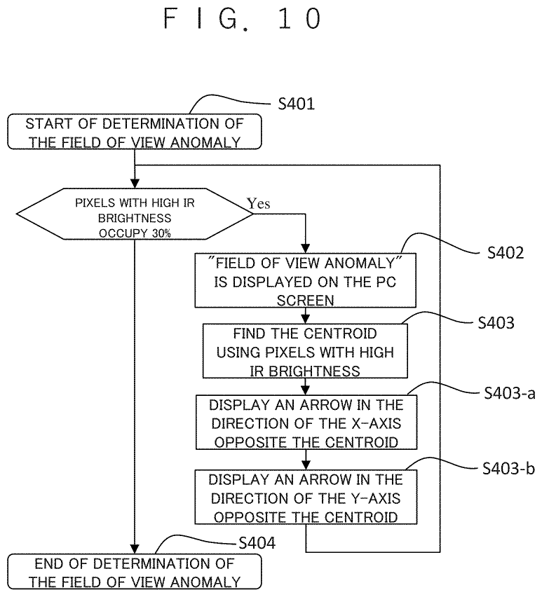

The details of the processing when the field of view anomaly is determined will be described with reference to FIG. 10. FIG. 10 is a flowchart showing an example of processing when the determination of the field of view anomaly is started. When the determination of the field of view anomaly is started (step 401), the information indicating the field of view anomaly is displayed on the PC screen (step 402). Then, the centroid of the region having high IR brightness is obtained by using the pixels having high IR brightness (step 403). Then, an arrow pointing in the X-axis direction (left-right direction in the IR image) opposite to the centroid of the region with high IR brightness is displayed (step 403-a), and further, an arrow pointing in the Y-axis direction (up and down direction in the IR image) opposite to the centroid of the region having high IR brightness is displayed (step 403-b). Note that, the order of the processes according to steps 403-a and 403-b is not particularly limited. Further, the process according to step 402 may be performed after the arrow display process, for example, and the timing at which the process is started may be appropriately changed. Then, when the field of view anomaly is resolved, the process ends (step 404). Here, in the step 404, a process of ending the display of information may be performed.

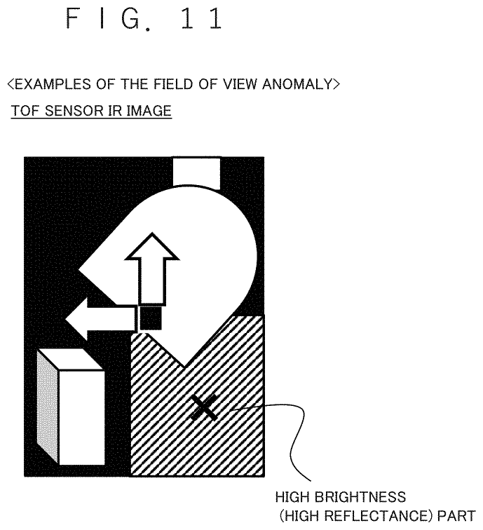

The details of the display on the screen 54 will be described with reference to FIG. 11. FIG. 11 is a diagram showing an example of a display image in the case of the field of view anomaly. As shown in FIG. 11, on the screen 54, in the IR image acquired by the TOF sensor 42 in the current installation state, a mark indicating the position of the centroid of the IR image, a mark indicating the position of the centroid in the high-brightness region, and an arrow indicating a direction to avoid a region having high brightness, are displayed. In the present embodiment, the position of the mark in the high brightness area is referred to, and the arrow corresponding to the direction away from the high brightness area is selected and displayed from the four types of arrows pointing up, down, left, and right from the centroid of the IR image. More specifically, in the example of FIG. 11, the mark in the region with high brightness is located on the lower right side of the centroid of the IR image. Therefore, to indicate that the changing to direction away from this mark (that is, the direction away from the high brightness area and the direction for correcting the field of view anomaly), an arrow pointing to the left (arrow in the X-axis direction) and an arrow pointing up (arrow in the Y-axis direction) are displayed.

Note that, the display mode of the mark indicating the position of the centroid of the IR image and the mark indicating the position of the centroid in the region where the brightness is high may be appropriately changed. Further, these marks may be omitted as appropriate. Further, the display mode of the arrow may be changed as appropriate as long as it can grasp the direction away from the region where the brightness is high.

Then, by changing the installation state based on the information displayed on the screen 54 (for example, by tilting in the direction of the arrow to change the installation angle), the field of view anomaly can be resolved. Note that, by changing the installation location (for example, by changing the installation location of the device in the direction of the arrow), the field of view anomaly may be resolved. Further, similarly to the above, the screen 54 displays information for selecting whether to continue the measurement (step 225), and when the measurement is selected to be continued, the step 203 is executed again. When choosing not to continue the measurement, the step 208 described below is performed.

In the step 207, an anomaly in the measured distance is determined in the same manner as in the step 107 described above, and when it is determined that the distance data of less than 1 m does not occupy 30% of the image, the step 208 is executed. On the other hand, when it is determined that the distance data of less than 1 m occupies 30% or more in the image, the information indicating the distance anomaly, and an arrow indicating the direction (that is, the direction to correct the anomaly distance) to correct the sensor are displayed on the screen 54 (step 224). Note that, the display mode of the information indicating the distance anomaly is not particularly limited as long as the distance anomaly can be grasped, as in the case described above.

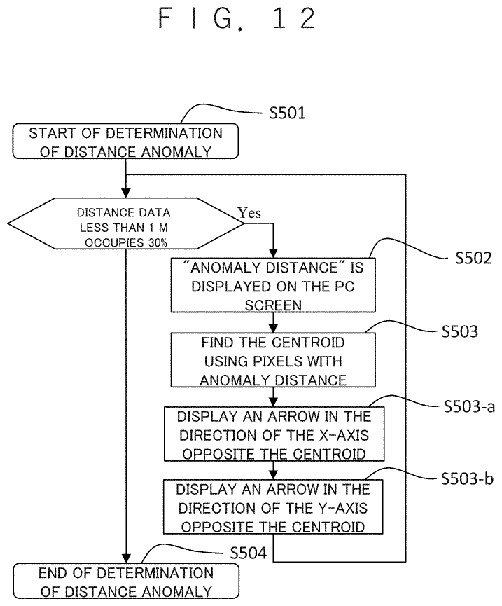

The details of the processing when the distance anomaly is determined will be described with reference to FIG. 12. FIG. 12 is a flowchart showing an example of processing when the determination of the distance anomaly is started. When the determination of the distance anomaly is started (step 501), the information indicating the distance anomaly is displayed on the PC screen (step 502), and the centroid of the distance abnormality region is obtained using the distance anomaly pixel (step 503). Then, an arrow pointing in the X-axis direction (left-right direction in the image of the distance data) opposite to the centroid of the region of the distance anomaly is displayed (step 503-a), and further, an arrow pointing in the Y-axis direction (up and down direction in the image of the distance data) opposite to the centroid of the region of the distance anomaly is displayed (step 503-b). Note that, the order of the processes according to steps 503-a and 503-b is not particularly limited. Further, the process according to step 502 may be performed after the arrow display process, for example, and the timing at which the process is started may be appropriately changed. Then, when the distance anomaly is resolved, the process ends (step 504). Here, in the step 504, a process of ending the display of information may be performed.

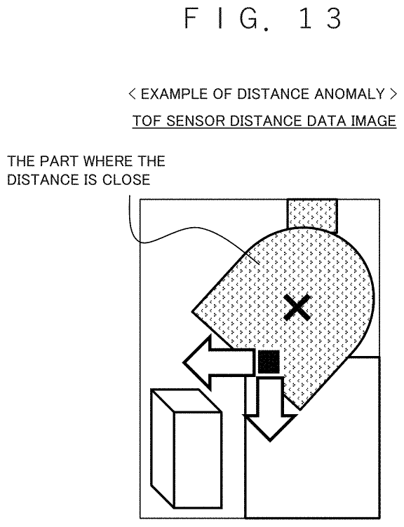

The details of the display on the screen 54 will be described with reference to FIG. 13. FIG. 13 is a diagram showing an example of a display image in the case of an anomaly distance. As shown in FIG. 13, on the screen 54, in the image of the distance data acquired by the TOF sensor 42 in the current installation state, a mark indicating the position of the centroid of the image of the distance data, a mark indicating the position of the centroid in the anomaly distance region, and an arrow indicating a direction to avoid a region having anomaly distance, are displayed. In the present embodiment, the position of the mark in the anomaly distance area is referred to, and the arrow corresponding to the direction away from the anomaly distance area is selected and displayed from the four types of arrows pointing up, down, left, and right from the centroid of the image of the distance data. More specifically, in the example of FIG. 13, the mark in the region with anomaly distance is located on the upper right side of the centroid of the image of the distance data. Therefore, to indicate that the changing to direction away from this mark (that is, the direction away from the area of distance data less than a predetermined distance and the direction of correcting the distance anomaly), an arrow pointing to the left (arrow in the X-axis direction) and an arrow pointing down (arrow in the Y-axis direction) are displayed.

Note that, the display mode of the mark indicating the position of the centroid of the image of the distance data and the mark indicating the position of the centroid in the region where the distance is anomaly may be appropriately changed. Further, these marks may be omitted as appropriate. Further, the display mode of the arrow may be changed as appropriate as long as it can grasp the direction away from the region of the distance data less than the predetermined distance.

Then, by changing the installation state with reference to the arrow displayed on the screen 54 (for example, by tilting in the direction of the arrow to change the installation angle), the distance anomaly can be resolved. Note that, by changing the installation location (for example, by changing the installation location of the device in the direction of the arrow), the distance anomaly may be resolved. Further, the screen 54 displays information for selecting whether to continue the measurement (step 225), and when the measurement is selected to be continued, the step 203 is executed again. On the other hand, when choosing not to continue the measurement, the step 208 is performed.

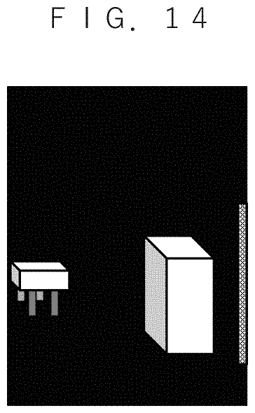

In the step 208, a command is issued to turn off the laser (that is, turn off the light source) and stop the acquisition of distance data and IR images. Then, the anomaly determination program 61 ends (step 209). By executing this anomaly determination program 61, as shown in FIG. 14, the TOF sensor 42 can be installed so that there is no anomaly in the field of view, the measurement distance, or the like, and appropriate measurement can be performed.

According to this embodiment, from the viewpoint of the installation angle, the presence or absence of interference, the anomaly of the field of view, and the anomaly of the measurement distance, it is determined whether or not the installation state of the TOF sensor 42 is appropriate, when it is determined to be anomaly, the information is displayed on the screen 54 as the notification content. Then, appropriate Installation work can be performed by referring to the content of the notification. Therefore, it is possible to reduce the loss of performing the Installation work again from the viewpoint of accuracy after the operation is started.

According to the embodiments described above, an installation status notification method executed by a processor is provided. The installation status notification method determines whether the TOF apparatus installed state is normal or anomaly based on at least one of the viewpoints of the installation angle, the influence of interference, the field of view, and the measurement distance, and the measurement distance, and notify the determination result. Further, a program for causing the processor to execute the installation status notification method is provided.

Hereinbefore, the embodiment has been described, but the invention is not limited to the above-described embodiment, and includes various modifications. For example, addition, deletion, or substitution of another configuration can be made with respect to a part of the configuration of the embodiment.

As an example of the processor, the CPU is considered, but another semiconductor device (for example, GPU) may be employed as long as the other semiconductor device is a main body that executes predetermined processes.

The criteria for determining the installation angle, the presence or absence of interference, the anomaly of the field of view, and the anomaly of the distance can be changed as appropriate. For example, in the above explanation, the reference value of the installation angle is plus or minus 5 degrees, but if it can be appropriately determined whether or not it is within an appropriate range, the reference value of the installation angle may be appropriately changed. Regarding the presence or absence of interference, it suffices if an appropriate determination is made based on the variation in distance data, distance data with a time different from 10 seconds may be used, or the determination may be made based on variations other than 10%. Regarding the field of view anomaly, it suffices if an appropriate determination is made, and the reference value of the luminance used for the determination and the size of the region may be appropriately changed. Regarding the anomaly of the distance, it suffices if an appropriate determination is made, and the reference value of the distance and the size of the region used for the determination may be appropriately changed.

The acceleration sensor 23 may have a known configuration as long as it can appropriately detect the inclination angle with respect to the installation surface. Further, instead of the acceleration sensor 23, another known configuration such as a gyro sensor may be used as the installation angle detection sensor for detecting the installation angle. In the above description, the example in which the electric power is supplied by PoE has been described, but the electric power may be supplied by other appropriate means. Further, in the second embodiment, the communication by the ethernet 51 between the TOF sensor 42 and the PC 43 has been described, but the communication by another method may be performed.

An external display device may be used as the screen. In this case, the configuration related to the screen 54 in the PC 43 may be omitted.

What is claimed is:

1. A TOF apparatus, comprising:
a processor,
wherein the processor executes an anomaly determination program, determines whether the installed state is normal or anomaly based on at least one of the viewpoints of the installation angle, the influence of interference, the field of view, and the measurement distance, and notifies the determination result.

2. The TOF apparatus according to claim 1, further comprising:
A lamp,
wherein the processor executes the anomaly determination program, notifies the result of the determination by turning on or blinking the lamp.

3. The TOF apparatus according to claim 1, further comprising:
An installation angle detection sensor that detects the installation angle with respect to the installation surface,
in executing the anomaly determination program, wherein the processor makes the determination based on the installation angle, based on whether or not the installation angle detection sensor detects an installation angle equal to or greater than a predetermined angle with respect to the installation surface.

4. The TOF apparatus according to claim 1, wherein
in executing the anomaly determination program, the processor makes the determination based on the effect of interference, based on whether the distance data obtained from the object from a certain distance fluctuates.

5. The TOF apparatus according to claim 1, wherein
in executing the anomaly determination program, the processor makes the determination based on the field of view, based on the ratio of pixels whose brightness is equal to or higher than a predetermined value in the acquired IR image.

6. The TOF apparatus according to claim 1, wherein
in executing the anomaly determination program, the processor makes the determination based on the measured distance, based on the ratio of the distance data less than a predetermined distance in the image of the acquired distance data.

7. A TOF system comprising:
A TOF apparatus,
A display, and
A processor,
wherein the processor executes an anomaly determination program, determines whether the installed state is normal or anomaly based on at least one of the viewpoints of the installation angle, the influence of interference, the field of view, and the measurement distance, and displays information regarding the determination on the display.

8. The TOF system according to claim 7, wherein
the TOF apparatus includes an installation angle detection sensor that detects an installation angle with respect to the installation surface,
in executing the anomaly determination program, the processor makes the determination based on the installation angle, based on whether or not the installation angle detection sensor detects an installation angle equal to or greater than a predetermined angle with respect to the installation surface.

9. The TOF system according to claim 8, wherein
in executing the anomaly determination program, when it is determined that the state in which the TOF apparatus is installed is not normal, the processor displays information including an arrow indicating the direction for correcting the installation angle in the image acquired from the TOF apparatus on the display.

10. The TOF system according to claim 7, wherein
in executing the anomaly determination program, the processor makes the determination based on the effect of interference, based on whether the distance data obtained from the object from a certain distance fluctuates.

11. The TOF system according to claim 7, wherein
in executing the anomaly determination program, the processor makes the determination based on the field of view, based on the ratio of pixels whose brightness is equal to or higher than a predetermined value in the IR image acquired by the TOF apparatus.

12. The TOF system according to claim 11, wherein
in executing the anomaly determination program, when it is determined that the state in which the TOF apparatus is installed is not normal, the processor displays information including an arrow indicating a direction away from the region where the brightness is equal to or higher than a predetermined value in the IR image on the display.

13. The TOF system according to claim 7, wherein
in executing the anomaly determination program, the processor makes the determination based on the measured distance, based on the ratio of the distance data less than a predetermined distance in the image of the acquired distance data.

14. The TOF system according to claim 13, wherein
in executing the anomaly determination program, when it is determined that the state in which the TOF apparatus is installed is not normal, the processor displays information including an arrow indicating a direction away from the area of distance data less than a predetermined distance in the image of the distance data on the display.

15. An installation status notification method executed by the processor, comprising:
determining whether the TOF apparatus installed state is normal or anomaly based on at least one of the viewpoints of the installation angle, the influence of interference, the field of view, and the measurement distance, and the measurement distance, and
notifying the determination result.
